(19) United States
(12) Patent Application Publication
(10) Pub. No.: US 2002/0162816 A1
(43) Pub. Date: Nov. 7, 2002

(54) Bottle-feeding babies

(76) Inventor: Derek James Walsh, Rockdale (AU)

Correspondence Address: SMITH-HILL AND BEDELL, 12670 N W BARNES ROAD, SUITE 104, PORTLAND, OR, 97229

(21) Appl. No.: 10/189,042

(22) Filed: Jul. 2, 2002

Related U.S. Application Data
(60) Provisional application No. 60/308,947, filed on Jul. 30, 2001.

(30) Foreign Application Priority Data
Apr. 6, 2001 (AU) PR 4262
Apr. 5, 2002 (AU) 31411/02

(51) Int. Cl. A61J 9/08

(52) U.S. Cl. 215/11.1; 215/11.6; 215/276

(57) ABSTRACT

A coupling sleeve has internal screw-threads for enabling the sleeve to be screwed onto an externally threaded neck of a commercially available small bottle of water or other liquid. External screw-threads on the sleeve enable it to have screwed to it a cap-and-nipple combination of a baby's drinking bottle. A first seal is provided between the neck-rim of the bottle and the sleeve and a second seal is provided between an end-rim of the sleeve and an annular sealing flange on the nipple.

### CROSS-REFERENCE TO RELATED APPLICATION

This application claims benefit of the date of filing of U.S. Provisional Application No. 60/308,947 filed Jul. 30, 2001.

### FIELD OF THE INVENTION

This invention relates to bottle-feeding babies and is more specifically concerned with a coupling for a baby-feeding bottle.

### STATE OF THE ART

Families traveling away from home with a small baby, usually pre-fill a number of feeding bottles with required liquids before their departure. The liquids may be milk or milk substitutes, or simply water or other readily-commercially available liquids.

For a number of reasons the number of pre-filled feeding bottles may be insufficient. It then becomes necessary to purchase bottled water or other readily-commercially available liquid at a service station or shop, and to transfer the liquid into a feeding bottle from which the baby can drink it. If one of the emptied feeding bottles is used for this purpose, a prudent parent will first clean it as an unwashed feeding bottle which has remained empty in a hot climate for some hours, can be a source of infection for a small baby. For cleaning to be carried out properly, special routines have to be adopted and these can take time and require clean kitchen facilities to carry out.

### OBJECT OF THE INVENTION

An object of this invention is to ameliorate the problem explained above.

### THE INVENTION

In accordance with the present invention a coupling sleeve has: internal screw-threads for enabling the sleeve to be screwed onto an externally threaded neck of a commercially available small bottle of water or other liquid; first means for providing a seal between the neck-rim of the bottle and the sleeve; external screw-threads on the sleeve enabling it to have screwed to it a cap-and-nipple combination of a baby's drinking bottle; and, second means for forming a seal between an end-rim of the sleeve and an annular sealing flange on the nipple.

The advantage of the coupling sleeve of the invention is that it enables a commercially available bottle of water or other liquid to be fed to a baby by way of a conventional bottle nipple without having first to transfer the bottle contents into a baby's drinking bottle.

### PREFERRED FEATURES OF THE INVENTION

Preferably the internal and external threaded regions of the coupling sleeve are concentrically rather than axially arranged, as this lends itself to a more compact configuration. The sleeve can be sold separately or may be packaged with its own drinking nipple and cap for holding the nipple on the sleeve in a manner which enables the nipple, cap and sleeve to be separated for cleaning purposes. Alternatively the sleeve can be sold in a pack containing a conventional baby's drinking bottle so that the bottle cap and nipple combination can be fitted to either the drinking bottle or a commercially available bottle of water or other liquid.

Suitably the coupling sleeve is provided with a hand-grip to facilitate its tight attachment to, and release from the threaded neck of a commercially available small bottle of liquid.

### BRIEF DESCRIPTION OF THE DRAWINGS

The invention will now be described in more detail, by way of example, with reference to the accompanying drawings, in which:

FIG. 1 shows a coupling sleeve in side elevation,

FIG. 2 is a vertical section through the sleeve of FIG. 1,

FIG. 3 is a top plan view of FIG. 1, and

FIG. 4 shows a combination of drinking bottle cap-and-nipple attached to one end of the sleeve which is screwed onto a 350 cc commercially available bottle of drinking water.

### DESCRIPTION OF THE PREFERRED EMBODIMENT

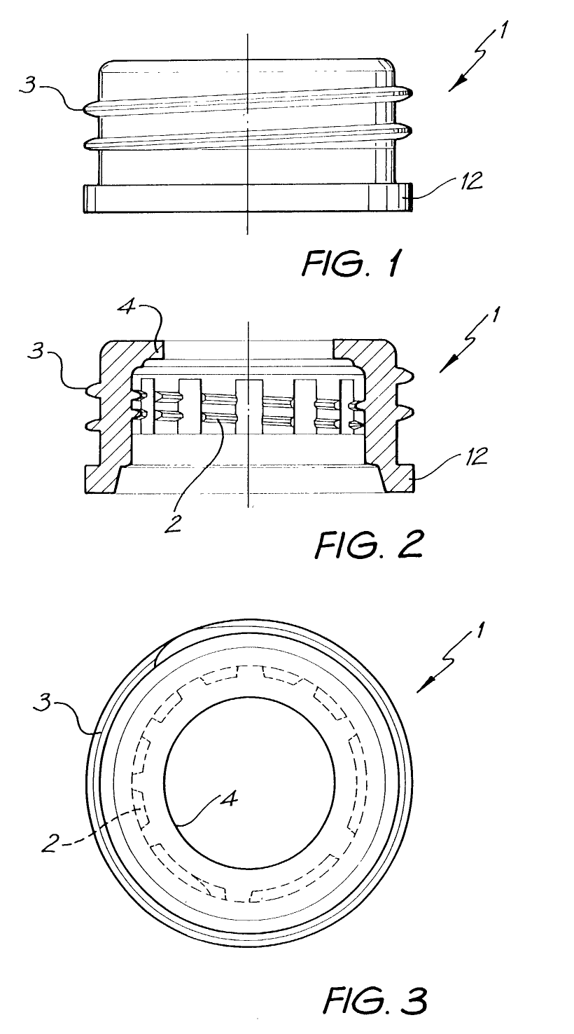

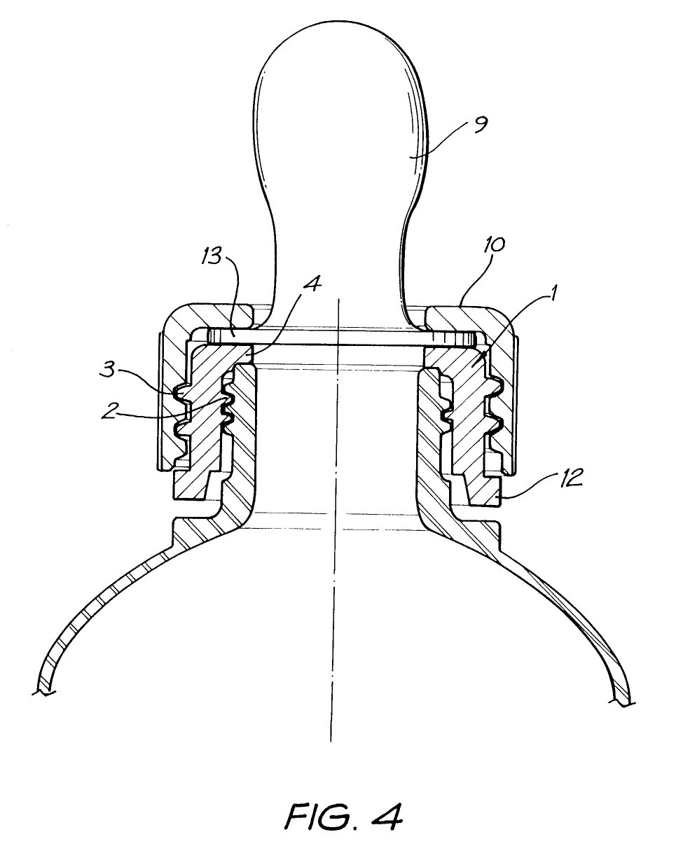

FIGS. 1, 2 and 3 show a coupling sleeve 1 made of plastics material and internally threaded at 2 with a circumferentially-interrupted thread, and externally threaded at 3. The sleeve is formed at one end with an inwardly-turned annular flange 4. The other end of the sleeve 1 may be shaped to provide a hand-grip for facilitating the attachment of the sleeve 1 to a commercially-available bottle of water as partially shown diagrammatically in FIG. 4.

The sleeve 1 is sold with a combination of nipple 9 and cap 10 both of which are shown in FIG. 4. The nipple 9 has an integral radial flange 13. When the sleeve 1 is in its operating mode, the soft nipple 9 has its radial flange 13 compressed between the outside surface of the coupling flange 4 and the inside surface of the cap 10 to form a seal therebetween. The extent to which the cap 10 screwed down onto the sleeve 1 may be limited by an abutment flange 12 located beneath the threads 3. However this is not normally necessary. When the combination of nipple 9 and cap 10 is in its transport mode the position of the nipple 9 and the cap 10 is reversed, so that the external surface of the nipple which enters the baby's mouth is protected to some extent by being located within the internal cavity of the sleeve 1.

### USE OF PREFERRED EMBODIMENT

The coupling sleeve 1 is used as follows:

After purchase of a small sealed bottle of sterile water or liquid, its screw cap is removed and the sleeve 1 is screwed onto the bottle in its place.

When the bottle is to be used to provide liquid to the baby, the cap 10 is temporarily removed to allow the nipple 9 to be reversed, and the cap 10 is then replaced on the sleeve 1 and screwed down hard. The bottled water or other liquid can then be given to the baby by way of the nipple, without risk of leakage.

1. A coupling sleeve having internal screw-threads for enabling the sleeve to be screwed onto an externally threaded neck of a commercially available small bottle of water or other liquid; first means for providing a seal between the neck-rim of the bottle and the sleeve; external screw-threads on the sleeve enabling it to have screwed to it a cap-and-nipple combination of a baby's drinking bottle; and, second means for forming a seal between an end-rim of the sleeve and an annular sealing flange on the nipple.

2. A coupling as set forth in claim 1, in which the internal and external threads of the coupling sleeve are concentrically arranged.

3. A coupling as set forth in claim 2, in which the internal threads are circumferentially-interrupted.

4. A package containing a sleeve as set forth in claim 1, the package also containing its own drinking nipple and cap for holding the nipple on the sleeve in a manner which enables the nipple, cap and sleeve to be separated for cleaning purposes.
